(19) United States
(12) Patent Application Publication
(10) Pub. No.: US 2025/0245963 A1
(43) Pub. Date: Jul. 31, 2025

(54) DETECTION AND CLASSIFICATION OF STEREO MODE IN IMAGE

(71) Applicant: Samsung Electronics Co., Ltd., Suwon-si (KR)

(72) Inventors: Mallikarjun Swamy, Sunnyvale, CA (US); Sambu Patach Arrojula, Santa Clara, CA (US); Aamer Khani, Dublin, CA (US); Siva Boggala, San Ramon, CA (US)

(21) Appl. No.: 19/038,498

(22) Filed: Jan. 27, 2025

Related U.S. Application Data
(60) Provisional application No. 63/626,880, filed on Jan. 30, 2024.

(51) Int. Cl. G06V 10/74; G06T 7/10; G06V 10/75

(52) U.S. Cl. CPC G06V 10/761; G06T 7/10; G06V 10/758

(57) ABSTRACT

A method includes obtaining an image, dividing the image vertically into first and second vertical halves, determining a first similarity score representing a similarity between the first and second vertical halves, and determining a first histogram score representing a resemblance between histograms of the first and second vertical halves. The method also includes dividing the image horizontally into first and second horizontal halves, determining a second similarity score representing a similarity between the first and second horizontal halves, and determining a second histogram score representing a resemblance between histograms of the first and second horizontal halves. The method further includes identifying whether the image is a left-right (LR) stereo image, a top-bottom (TB) stereo image, or a mono image using the first and second similarity scores and the first and second histogram scores.

### CROSS-REFERENCE TO RELATED APPLICATION AND PRIORITY CLAIM

This application claims priority under 35 U.S.C. § 119 (e) to U.S. Provisional Patent Application No. 63/626,880 filed on Jan. 30, 2024, which is hereby incorporated by reference in its entirety.

### TECHNICAL FIELD

This disclosure relates generally to image processing. More specifically, this disclosure relates to detection and classification of a stereo mode in images.

### BACKGROUND

Videos and/or images used for devices such as extended reality (XR) devices can be classified into categories such as a monocular (mono) image type (where the mono image type is an image that is captured using a single camera) and a stereoscopic (stereo) image type (where the stereo image type is an image captured using multiple cameras to provide a perception of depth). Since it is not mandatory to specify the format of these videos and/or images when publishing the videos and/or images, it is difficult for a video player or image viewer to determine if the content is mono or stereo. It is also difficult for the video player or image viewer to determine what type of stereo mode is being used.

### SUMMARY

This disclosure relates to detection and classification of a stereo mode in images.

In a first embodiment, a method includes obtaining, using at least one processing device of an electronic device, an image and dividing the image vertically into a first vertical half and a second vertical half. The method also includes determining, using the at least one processing device, a first similarity score representing a similarity between the first vertical half and the second vertical half, where the first similarity score is based on pixel differences between the first vertical half and the second vertical half. The method further includes determining, using the at least one processing device, a first histogram score representing a resemblance between histograms of the first vertical half and the second vertical half. The method also includes dividing, using the at least one processing device, the image horizontally into a first horizontal half and a second horizontal half. The method further includes determining, using the at least one processing device, a second similarity score representing a similarity between the first horizontal half and the second horizontal half, where the second similarity score is based on pixel differences between the first horizontal half and the second horizontal half. The method also includes determining, using the at least one processing device, a second histogram score representing a resemblance between histograms of the first horizontal half and the second horizontal half. In addition, the method includes identifying, using the at least one processing device, whether the image is a left-right (LR) stereo image type, a top-bottom (TB) stereo image type, or a mono image type using the first similarity score, the second similarity score, the first histogram score, and the second histogram score.

In a second embodiment, an electronic device includes at least one processing device configured to obtain an image and divide the image vertically into a first vertical half and a second vertical half. The at least one processing device is also configured to determine a first similarity score representing a similarity between the first vertical half and the second vertical half, where the first similarity score is based on pixel differences between the first vertical half and the second vertical half. The at least one processing device is further configured to determine a first histogram score representing a resemblance between histograms of the first vertical half and the second vertical half. The at least one processing device is also configured to divide the image horizontally into a first horizontal half and a second horizontal half. The at least one processing device is further configured to determine a second similarity score representing a similarity between the first horizontal half and the second horizontal half, where the second similarity score is based on pixel differences between the first horizontal half and the second horizontal half. The at least one processing device is also configured to determine a second histogram score representing a resemblance between histograms of the first horizontal half and the second horizontal half. In addition, the at least one processing device is configured to identify whether the image is an LR stereo image type, a TB stereo image type, or a mono image type using the first similarity score, the second similarity score, the first histogram score, and the second histogram score.

In a third embodiment, a non-transitory machine readable medium includes instructions that when executed cause at least one processor of an electronic device to obtain an image and divide the image vertically into a first vertical half and a second vertical half. The non-transitory machine readable medium also includes instructions that when executed cause the at least one processor to determine a first similarity score representing a similarity between the first vertical half and the second vertical half, where the first similarity score is based on pixel differences between the first vertical half and the second vertical half. The non-transitory machine readable medium further includes instructions that when executed cause the at least one processor to determine a first histogram score representing a resemblance between histograms of the first vertical half and the second vertical half. The non-transitory machine readable medium also includes instructions that when executed cause the at least one processor to divide the image horizontally into a first horizontal half and a second horizontal half. The non-transitory machine readable medium further includes instructions that when executed cause the at least one processor to determine a second similarity score representing a similarity between the first horizontal half and the second horizontal half, where the second similarity score is based on pixel differences between the first horizontal half and the second horizontal half. The non-transitory machine readable medium also includes instructions that when executed cause the at least one processor to determine a second histogram score representing a resemblance between histograms of the first horizontal half and the second horizontal half. In addition, the non-transitory machine readable medium also includes instructions that when executed cause the at least one processor to identify whether the image is an LR stereo image type, a TB stereo image type, or a mono image type using the first similarity score, the second similarity score, the first histogram score, and the second histogram score.

Any one or any combination of the following features may be used with the first, second, or third embodiment. The identification of whether the image is the LR stereo image type, the TB stereo image type, or the mono image type may include creating a first combined score using the first similarity score and the first histogram score, creating a second combined score using the second similarity score and the second histogram score, and using the first combined score and the second combined score to identify whether the image is the LR stereo image type, the TB stereo image type, or the mono image type. The first combined score may represent a likelihood that the image is the LR stereo image type. The second combined score may represent a likelihood that the image is the TB stereo image type. The identification of whether the image is the LR stereo image type, the TB stereo image type, or the mono image type may include estimating that the image is one of the LR stereo image type or the TB stereo image type based on a score threshold and identifying whether the image is the LR stereo image type or the TB stereo image type based on a comparison of the first combined score and the second combined score. The identification of whether the image is the LR stereo image type, the TB stereo image type, or the mono image type may include determining a first prediction, based on a score threshold and using the first similarity score and the first histogram score, of whether the image is the LR stereo image type; determining a second prediction, based on the score threshold and using the second similarity score and the second histogram score, of whether the image is the TB stereo image type; identifying, if the first prediction indicates the image is the LR stereo image type, the image as the LR stereo image type; identifying, if the second prediction indicates the image is the TB stereo image type, the image as the TB stereo image type; and identifying, if the first prediction and the second prediction indicate the image is neither the LR stereo image type nor the TB stereo image type, the image as the mono image type. The first vertical half and the second vertical half may be normalized for exposure and/or brightness prior to determining the first similarity score, and the first horizontal half and the second horizontal half may be normalized for exposure and/or brightness prior to determining the second similarity score. The histograms of the first vertical half and the second vertical half and the histograms of the first horizontal half and the second horizontal half may each represent pixel value frequencies in the one of the first vertical half, the second vertical half, the first horizontal half, and the second horizontal half of the image.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device in accordance with this disclosure;

FIGS. 2A-2C illustrate example image frames in different image modes in accordance with this disclosure;

FIG. 3 illustrates an example image mode identification process in accordance with this disclosure;

FIGS. 4A-4F illustrate example divided image frames in various formats in accordance with this disclosure;

FIGS. 5A and 5B illustrate example histograms in accordance with this disclosure;

FIG. 6 illustrates an example process for identifying a stereo mode of an image in accordance with this disclosure; and

FIG. 7 illustrates an example method for identifying the stereo mode for an image in accordance with this disclosure.

### DETAILED DESCRIPTION

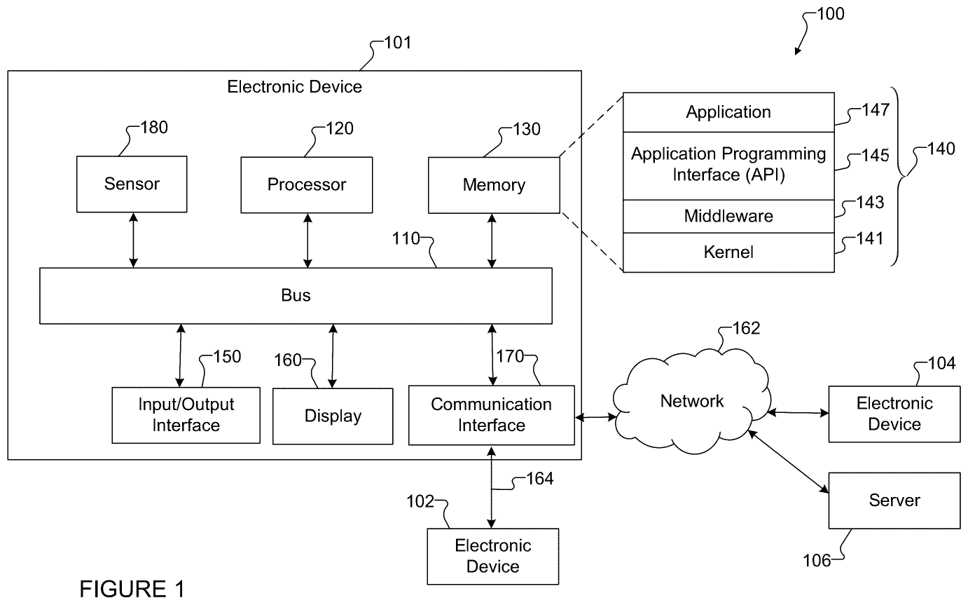

FIGS. 1 through 7, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, videos and/or images used for devices such as extended reality (XR) devices can be classified into categories such as a monocular (mono) image type (where the mono image type is an image that is captured using a single camera) and a stereoscopic (stereo) image type (where the stereo image type is an image captured using multiple cameras to provide a perception of depth). Since it is not mandatory to specify the format of these videos and/or images when publishing the videos and/or images, it is difficult for a video player or image viewer to determine if the content is mono or stereo. It is also difficult for the video player or image viewer to determine what type of stereo mode is being used.

In some solutions, metadata may be included in or with the videos or images and indicate the content type and the stereo mode. In other solutions, a video player and/or image viewer can have certain machine learning capabilities to detect the stereo mode by inspecting the image or video frame. However, as a practical matter, video players and image viewers cannot consistently rely on metadata to identify the stereo mode because not every video or image will have the correct metadata, such as via an error in applying the metadata. Moreover, solutions that use machine learning are computationally expensive. These limitations force existing solutions to rely on user input, degrading the user experience.

This disclosure provides various systems and processes that can identify the stereo mode of a video and/or image accurately by inspecting its content. Various embodiments of this disclosure provide for systems and methods of splitting or dividing an image vertically and/or horizontally and determining the similarity between the two halves of the image in order to identify the image as either a stereo image or a mono image. Additionally, various embodiments of this disclosure allow for determining a stereo image type of an image, such as whether the image is a left-right stereo image type (the stereo images are orientated side-by-side or horizontally) or a top-bottom stereo image type (the stereo images are orientated on top of each other or vertically). As described in this disclosure, similarity scores based on pixel comparisons between divided images can be determined. In various embodiments, histogram scores calculated using histograms created from the divided images can also be determined. These scores can be used to identify whether the image is a left-right stereo image, a top-bottom stereo image, or a mono image.

Note that while some of the embodiments discussed below are described in the context of use in consumer electronic devices (such as smartphones), this is merely one example. It will be understood that the principles of this disclosure may be implemented in any number of other suitable contexts and may use any suitable device or devices. In general, this disclosure is not limited to use with any specific type(s) of device(s).

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to detection and classification of a stereo mode in images, such as still or video images.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related detection and classification of a stereo mode in images. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that include one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform various operations related to detection and classification of a stereo mode in images, such as still or video images.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

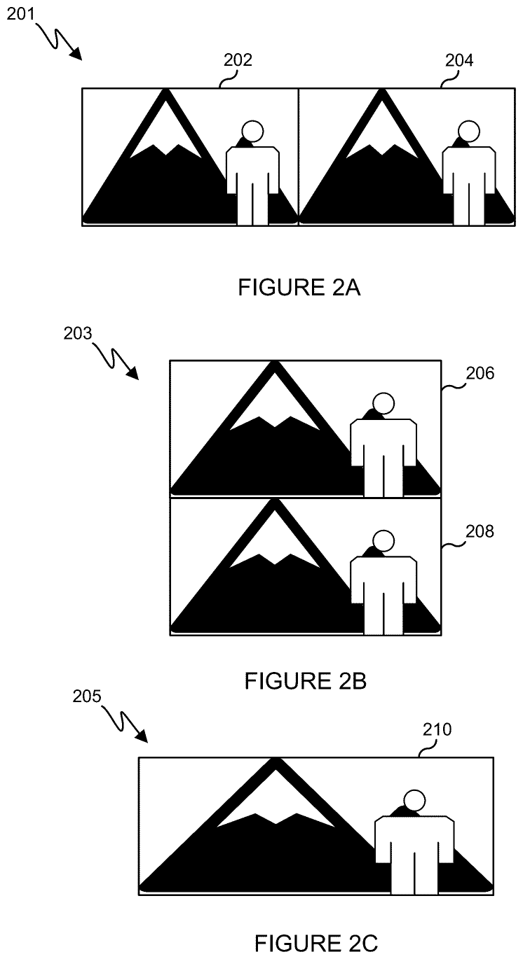

FIGS. 2A through 2C illustrate example image frames in different image modes in accordance with this disclosure. For ease of explanation, the example image frames shown in FIGS. 2A through 2C may be described as being used by the electronic device 101 in the network configuration 100 of FIG. 1. However, the examples image frames shown in FIGS. 2A through 2C could be used with any other suitable device(s) and in any other suitable system(s), such as when the example image frames are used by the server 106.

FIG. 2A illustrates an image frame 201 in a stereo left-right (LR) mode, where (i) a scene is captured using two cameras and (ii) first and second images 202, 204 are arranged in the image frame 201 in a side-by-side or horizontal configuration. FIG. 2B illustrates an image frame 203 in a stereo top-bottom (TB) mode, where (i) a scene is captured using two cameras and (ii) first and second images 206, 208 are arranged in the frame in a stacked or vertical configuration. FIG. 2C illustrates an image frame 205 in a mono mode, where the scene is captured using a single camera and includes a single image 210.

As shown in FIGS. 2A through 2C, the modes are classified based on the number of views captured for each image and how they are aligned. This disclosure provides for accurately detecting if an image is in a stereo format (such as shown in FIGS. 2A and 2B) or in a mono format (such as shown in FIG. 2C). Additionally, for stereo images, this disclosure provides for further identifying, with reduced or minimal computational costs, the type of stereo format an image is in, such as whether the image is in the stereo LR mode or the stereo TB mode.

Although FIGS. 2A through 2C illustrate examples of image frames in different image modes, various changes may be made to FIGS. 2A through 2C. For example, although the example image frames 201, 203, 205 illustrate a particular captured environment or scene, it will be understood that the image frames could include any captured environment or scene. Additionally, it will be understood that this disclosure can be used with single still images or with video images, where at least some images in the video can be classified based on the systems and methods of this disclosure.

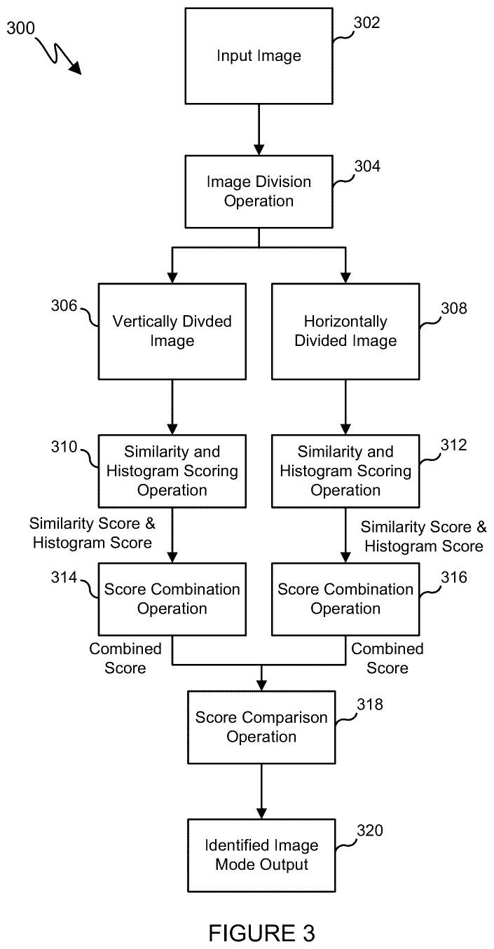

FIG. 3 illustrates an example image mode identification process 300 in accordance with this disclosure. For ease of explanation, the process 300 is described as involving the use of the electronic device 101 in the network configuration 100 of FIG. 1. However, the process 300 may be used with any other suitable electronic device (such as the server 106) or a combination of devices (such as the electronic device 101 and the server 106) and in any other suitable system(s).

As shown in FIG. 3, an input image 302 is obtained. As described in this disclosure, the input image 302 can be in a particular image mode or format. For example, the input image 302 can be a 360° video image frame that is in one of a stereo LR format, a stereo TB format, or a mono format. To determine the format of the input image 302, the process 300 divides the input image 302 using an image division operation 304 that creates two outputs, a vertically-divided image 306 and a horizontally-divided image 308. Creating both a vertically-divided image 306 and a horizontally-divided image 308 allows the process 300 to determine which of the stereo LR mode or the stereo TB mode the image is in or if the image is in a mono mode.

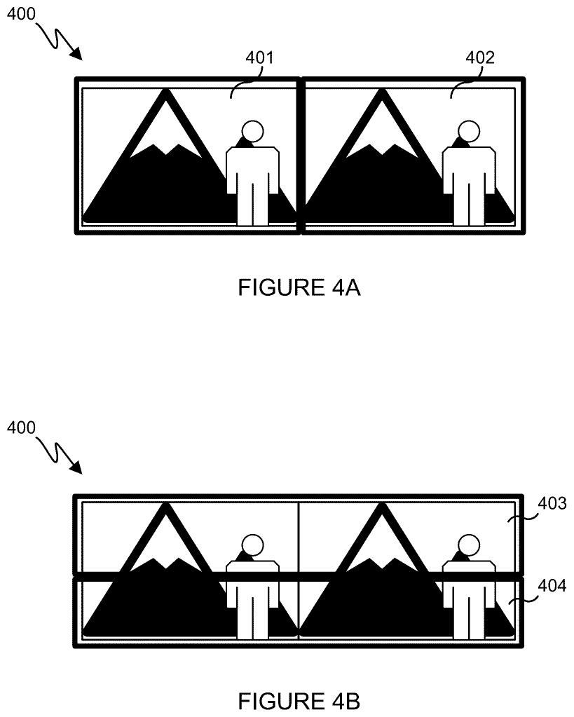

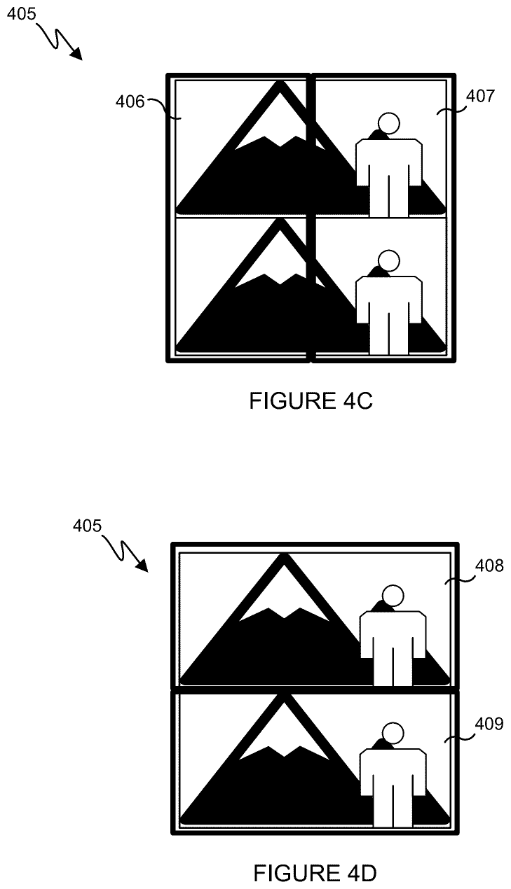

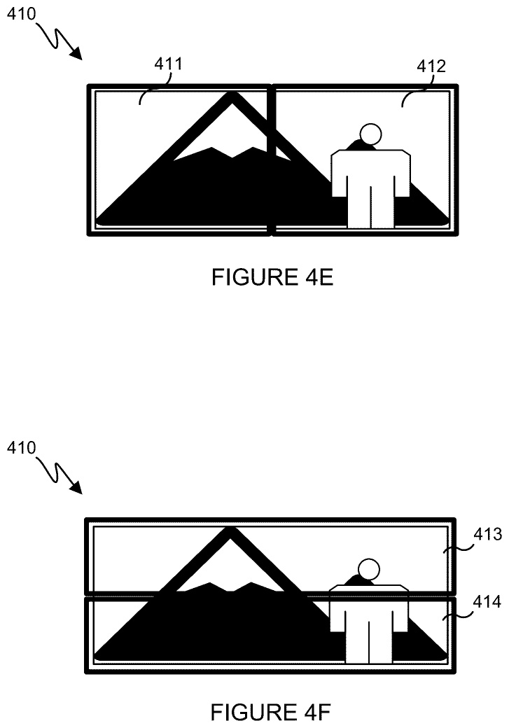

As an example, FIGS. 4A-4F illustrate example divided image frames in various formats in accordance with this disclosure. More specifically, FIG. 4A shows an image frame 400 in the stereo LR mode that is split horizontally, such as by the image division operation 304, into a first horizontal half 401 and a second horizontal half 402. FIG. 4B shows the image frame 400 in the stereo LR mode split vertically, such as by the image division operation 304, into a first vertical half 403 and a second vertical half 404. As shown in FIGS. 4A and 4B, since the image frame 400 is in the stereo LR mode, the first horizontal half 401 and the second horizontal half 402 will be substantially similar when split horizontally as shown in FIG. 4A, and the first vertical half 403 and the second vertical half 404 will be dissimilar when split vertically as shown in FIG. 4B. Because of this, a result of the scoring and evaluation carried out by the remainder of the process 300 can provide an output indicating that the image frame 400 is in the stereo LR mode.

To further illustrate how the similarity of split images is used to differentiate between the image modes, FIG. 4C shows an image frame 405 in the stereo TB mode that is split horizontally, such as by the image division operation 304, into a first horizontal half 406 and a second horizontal half 407. FIG. 4D shows the image frame 405 in the stereo TB mode split vertically, such as by the image division operation 304, into a first vertical half 408 and a second vertical half 409. As shown in FIGS. 4C and 4D, since the image frame 405 is in the stereo TB mode, the first horizontal half 406 and the second horizontal half 407 will be dissimilar when split horizontally as shown in FIG. 4C, and the first vertical half 408 and the second vertical half 409 will be substantially similar when split vertically as shown in FIG. 4D. Because of this, a result of the scoring and evaluation carried out by the remainder of the process 300 can provide an output indicating that the image frame 405 is in the stereo TB mode.

FIG. 4E shows an image frame 410 in the mono mode that is split horizontally, such as by the image division operation 304, into a first horizontal half 411 and a second horizontal half 412. FIG. 4F shows the image frame 410 in the mono mode split vertically, such as by the image division operation 304, into a first vertical half 413 and a second vertical half 414. As shown in FIGS. 4E and 4F, since the image frame 410 is in the mono mode, the first horizontal half 411 and the second horizontal half 412 will be dissimilar when split horizontally as shown in FIG. 4E, and the first vertical half 413 and the second vertical half 414 will also be dissimilar when split vertically as shown in FIG. 4F. Because of this, a result of the scoring and evaluation carried out by the remainder of the process 300 can provide an output indicating that the image frame 410 is in the mono mode.

As shown in FIG. 3, once the image frame is divided into the vertically-divided image 306 and the horizontally-divided image 308, a similarity and histogram scoring operation 310 processes the vertically-divided image 306 to determine a similarity score and a histogram score for the vertically-divided image 306. Likewise, a similarity and histogram scoring operation 312 processes the horizontally-divided image 308 to determine a similarity score and a histogram score for the horizontally-divided image 308.

The similarity scores represent pixel differences between the two image halves of the respective vertically-divided image 306 and the horizontally-divided image 308. In some cases, the similarity scores can be generated based on normalized pixel values to capture low-level resemblance between the image halves in the respective vertically-divided image 306 and the horizontally-divided image 308. For example, the normalization can include normalizing the image for brightness and/or exposure. The histogram scores can be determined by first creating a histogram for each of the two image halves for each of the respective vertically-divided image 306 and the horizontally-divided image 308 and determining a score using the two histograms to capture high-level resemblances between the image halves for each of the respective vertically-divided image 306 and the horizontally-divided image 308.

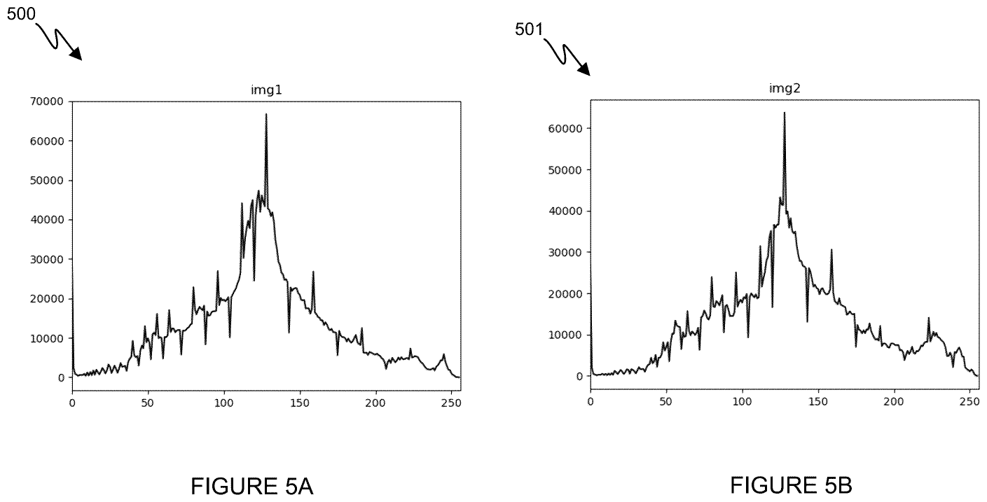

It will be understood that the histograms created for the respective halves of the vertically-divided image 306 and the horizontally-divided image 308 represent the frequency that pixel values appear in the respective image half. For instance, FIGS. 5A and 5B illustrate example histograms 500 and 501 in accordance with this disclosure. More specifically, FIG. 5A represents a histogram 500 created for a first image half, such as either a first vertical image half of the vertically-divided image 306 or a first horizontal image half of the horizontally-divided image 308. FIG. 5B represents a histogram 501 created for a second image half, such as either a second vertical image half of the vertically-divided image 306 or a second horizontal image half of the horizontally-divided image 308.

The y-axes of the histograms 500 and 501 indicate the frequency of pixel values, meaning the number of times the pixel value appears in the image. The x-axes of the histograms 500 and 501 indicate the pixel value. In this example, the histograms 500 and 501 include pixel values ranging from values of 0 and 255. As shown in FIGS. 5A and 5B, the image is indicated by the histograms 500 and 501 as having the most pixel values near a value of 125. In some embodiments, an RGB image can first be converted to grayscale before generating the histograms. In other embodiments, the image halves can remain as RGB images, and three histograms can be created for each image half. The use of other color spaces may also be supported by the process 300.

As shown in the example of FIGS. 5A and 5B, the two image halves are substantially similar, meaning the two histograms include similar values and a similar line shape. It will be understood that dissimilar histograms may be created, such as when a stereo LR image is divided vertically (as in FIG. 4B). In some cases, image shift can occur between horizontal or vertical image halves when capturing stereo LR or stereo TB images. However, histograms can be used in this disclosure to account for this tendency for image shift because the histogram representation is generally invariant to such shifts in the image seen in stereo formats. That is, the general structure of the histogram remains the same despite a large shift in the image. This structural similarity is exploited in this disclosure by the histogram score to improve the measured similarity between the two image halves.

To illustrate, in some embodiments, the similarity scores can be calculated using the following pseudocode:

```
# format can be lr or tb
def similarity_stereo_score(video_frame, format):
    # split video frame into two equal halves depending on the format
    frame1, frame2 = split_frame(video_frame, format)
    # normalize both frames using mean and standard deviation (std)
  frame1_normalized = (frame1 − mean(frame1, axis=(0, 1))) /
  std(frame1, axis=(0, 1))
  frame2_normalized = (frame2 − mean(frame2, axis=(0, 1))) /
  std(frame2, axis=(0, 1))
  difference =abs(frame1_normalized − frame2_normalized) # absolute
  value
  return 1 − (mean(difference)/max(difference))
# format can be lr or tb
def histogram_stereo_score(video_frame, format):
  # split video frame into two equal halves depending on the format
  frame1, frame2 = split_frame(video_frame, format)
  frame1_histogram = histogram(frame1)
  frame2_histogram = histogram(frame2)
  # component wise maximum and minimum of histograms
  histogram_max = max(frame1_histogram, frame2_histogram)
  histogram_max = max(frame1_histogram, frame2_histogram)
  return mean(histogram_min/histogram_max)
```

Once the similarity and histogram scores are determined, the scores for each of the vertically-divided image 306 and the horizontally-divided image 308 can be combined at score combination operations 314 and 316 as shown in FIG. 3. Two combined scores are output by the score combination operations 314 and 316, one for the vertically-divided image 306 and one for the horizontally-divided image 308. The combined scores can be referred to in this disclosure as stereo scores and can be used to determine a final classification of the image along with finetuned heuristics for thresholding. To illustrate, the combined scores can be calculated using the following pseudocode:

```
# format can be lr or tb
def compute_stereo_estimate(video_frame, format, alpha, beta,
threshold)
  # compute low level similarity based on normalized pixel differences
  similarity_score = similarity_stereo_score(video_frame, format)
  # compute histogram score to capture high level resemblance
  hist_score = histogram_stereo_score(video_frame, format)
  score = alpha * hist_score + beta * similarity_score
  max_score = max(hist_score, similarity_score)
  min_score = min(hist_score, similarity_score)
  return threshold < max_score < 2 * min_score, score
```

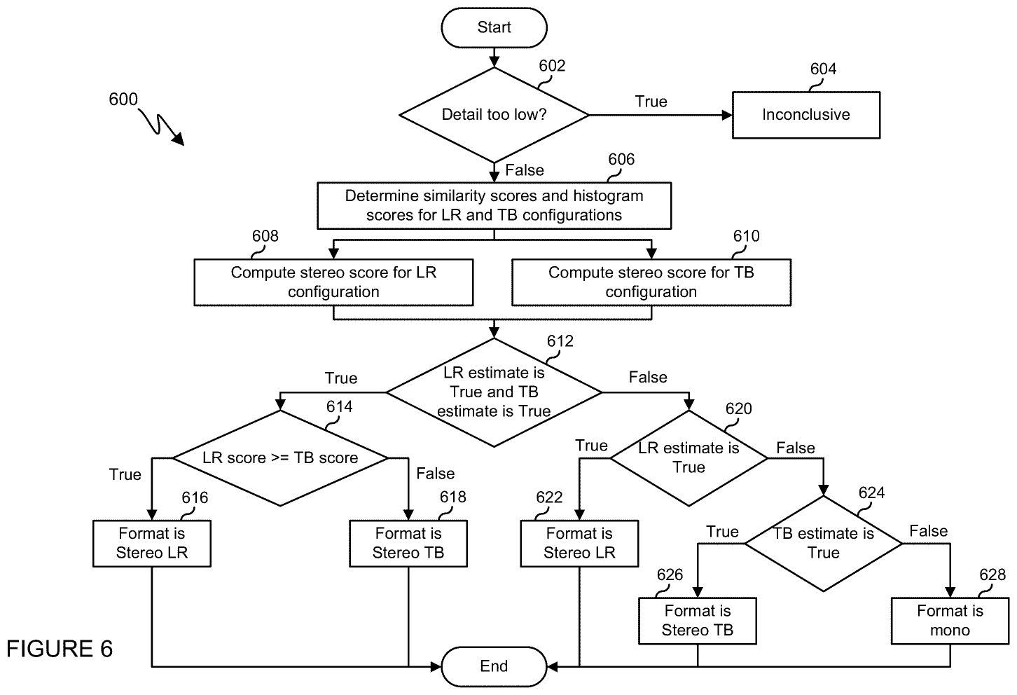

The combined scores can be used by a score comparison operation 318 to identify whether the input image 302 is a stereo LR image, a stereo TB image, or a mono image. One example implementation of the score comparison operation 318 is illustrated in FIG. 6 of this disclosure. Based on the identification, an identified image mode output 320 is provided. The identified mode assists image and/or video viewer applications or other applications with properly processing and displaying the images, as the image, video viewer, or other applications can be instructed as to the correct type of mode in which to display the images.

Although FIG. 3 illustrates one example of an image mode identification process 300, various changes may be made to FIG. 3. For example, while shown as a series of steps, various steps in FIG. 3 could overlap, occur in parallel, occur in a different order, or occur any number of times (including zero times). As a particular example, the image division operation could include two different operations, one for dividing the image into the vertically-divided image 306 and another for dividing the image into the horizontally-divided image 308. As another particular example, the similarity and histogram scoring operations 310 and 312 can be separate operations configured specifically for determining image scores for the respective vertically-divided image 306 or horizontally-divided image 308 or a single operation that takes either the vertically-divided image 306 or the horizontally-divided image 308 as inputs. As yet another particular example, the score combination operations 314 and 316 can be separate operations configured specifically for processing image scores for the respective vertically-divided image 306 or horizontally-divided image 308 or a single operation that takes the scores determined for either the vertically-divided image 306 or horizontally-divided image 308 as inputs.

Although FIGS. 4A through 4F illustrate examples of divided image frames in various formats, various changes may be made to FIGS. 4A through 4F. For example, although the example image frames 400, 405, 410 illustrate a particular captured environment or scene, it will be understood that the image could include any captured environment or scene. Additionally, it will be understood that this disclosure can be used with single still images or with video images, where at least some images in the video can be classified based on the systems and methods of this disclosure. Although FIGS. 5A and 5B illustrate examples of histograms 500 and 501, various changes may be made to FIGS. 5A and 5B. For instance, it will be understood that the histograms 500 and 501 are examples only and that the values shown in the histograms 500 and 501 can vary significantly from those shown in FIGS. 5A and 5B.

FIG. 6 illustrates an example process 600 for identifying a stereo mode of an image in accordance with this disclosure. For ease of explanation, the process 600 shown in FIG. 6 is described as being performed using the electronic device 101 in the network configuration 100 of FIG. 1. However, the process 600 could be performed using any other suitable device(s), such as the server 106, and in any other suitable system(s).

As shown in FIG. 6, at step 602, it is determined whether the image detail is too low to make a determination as to the stereo mode of the image. Step 602 can be an initial threshold check to ensure the image is of high enough quality for processing before continuing the process 600. If not, the process 600 outputs at step 604 a determination that the result is “inconclusive.” This can occur, for example, if the particular image frames being analyzed include completely black frames or have other detail issues.

If the detail is not too low, at step 606, the similarity scores and histogram scores are determined for the image in both the LR and TB configurations. Step 606 can include dividing the input image both horizontally and vertically and determining similarity and histogram scores for both the horizontally-divided and vertically-divided images, such as is described with respect to FIG. 3. At step 608, the stereo score for the LR configuration, meaning the horizontally-divided image, is computed. At step 610, the stereo score for the TB configuration, meaning the vertically-divided image, is computed. The stereo scores may represent the combined scores as described with respect to FIG. 3.

In some embodiments, steps 602 through 610 may be illustrated by the following pseudocode.

```
# stereo_mode can be stereo_lr, stereo_tb or mono
def detect(video_frame, alpha, score_threshold, detail_threshold,
pixel_bits=8)
  beta = 1− alpha
  range = 2\hat{ }(pixel_bits) − 1
  if (max(video_frame) − min(video_frame))/range <= detail_threshold:
    return ‘inconclusive’
  lr_estimate, lr_score = compute_stereo_estimate(video_frame, ‘lr’,
alpha, beta, score_threshold)
  tb_estimate, tb_score = compute_stereo_estimate(video_frame, ‘tb’,
alpha, beta, score-threshold)
```

In the pseudocode above, constraints for the parameters can be provided such that 0≤alpha≤1 and 0≤detail_threshold≤1. Also, note that pixel_bits equals the number of bits used to store one channel of pixel data. The “detail_threshold” in the above pseudocode can be a tunable parameter like the alpha parameter. These constraints can be used to weight the parameters. As also shown in the pseudo code above, in addition to computing the combined scores for both the LR configuration and the TB configuration, an estimate for each of the LR configuration (lr_estimate) and the TB configuration (tb_estimate) can be determined, which (in some embodiments) may each be a Boolean value that is true or false.

At step 612, it is determined whether both the LR estimate and the TB estimate are true. This may be the case, for example, when the split images for both the vertically-divided image and the horizontally-divided image are close enough that both estimates equate to true. If such is the case, at step 614, a tiebreaker scenario is entered in which the combined scores (the LR score and the TB score) are compared. If the LR score is greater than or equal to the TB score, at step 616, it is determined that the image is of the stereo LR type. However, if, at step 614, it is determined that the LR score is not greater than or equal to the TB score, at step 618, it is determined that the image is of the stereo TB type.

If, at step 612, it is determined that not both the LR estimate and the TB estimate are true, at step 620, it is determined if the LR estimate alone is true. If so, at step 622, it is determined that the image is in the stereo LR format. If not, at step 624, it is determined whether the TB estimate is true. If so, at step 626, it is determined that the image is in the stereo TB format. However, if, at steps 620 and 624, it is determined the LR estimate and the TB estimate are both false, at step 628, it is determined that the image is in the mono format.

The score comparison operation 318 of FIG. 3 can include steps 612-628. In some embodiments, steps 612-628 can be illustrated by the following pseudocode.

```
if lr_estimate and tb_estimate:
    if lr_score >= tb_score:
      return ‘stereo_lr’
    else:
      return ‘stereo_tb’
  elseif lr_estimate: # else if
      return ‘stereo_lr’
  elseif tb_estimate: # else if
      return ‘stereo_tb’
return ‘mono’
```

The process 600 of FIG. 6 provides for a computationally-inexpensive algorithm. For example, the process 600 of FIG. 6 may represent a O (wh) algorithm, where w and h are the dimensions of the images being processed. As a result, this can provide a high accuracy for image classification with low computational complexity.

Although FIG. 6 illustrates one example of a process 600 for identifying a stereo mode of an image, various changes may be made to FIG. 6. For example, while shown as a series of steps, various steps in FIG. 6 could overlap, occur in parallel, occur in a different order, or occur any number of times (including zero times).

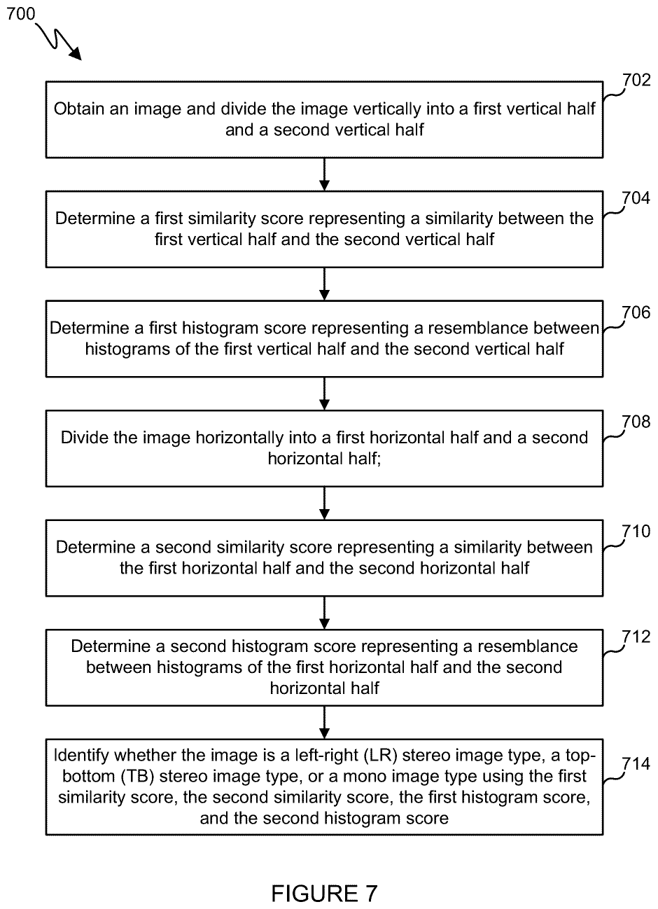

FIG. 7 illustrates an example method 700 for identifying the stereo mode for an image in accordance with this disclosure. For ease of explanation, the method 700 shown in FIG. 7 is described as being performed using the electronic device 101 in the network configuration 100 of FIG. 1. However, the method 700 could be performed using any other suitable device(s), such as the server 106, and in any other suitable system(s).

At step 702, an image is obtained, such as by an electronic device executing an image or video viewer application, and is divided vertically into a first vertical half and a second vertical half. This can include the processor 120 of electronic device 101 executing the image division operation 304. At step 704, a first similarity score is determined that represents a similarity between the first vertical half and the second vertical half. The first similarity score may be based on pixel differences between the first vertical half and the second vertical half. In various embodiments, the first vertical half and the second vertical half can be normalized for exposure and/or brightness prior to determining the first similarity score. At step 706, a first histogram score is determined representing a resemblance between histograms of the first vertical half and the second vertical half. Steps 704 and 706 can include the processor 120 executing the similarity and histogram scoring operation 310.

At step 708, the image is divided horizontally into a first horizontal half and a second horizontal half. This can include the processor 120 of electronic device 101 executing the image division operation 304. At step 710, a second similarity score is determined representing a similarity between the first horizontal half and the second horizontal half. The second similarity score may be based on pixel differences between the first horizontal half and the second horizontal half. In various embodiments, the first horizontal half and the second horizontal half can be normalized for exposure and/or brightness prior to determining the second similarity score. At step 712, a second histogram score is determined representing a resemblance between histograms of the first horizontal half and the second horizontal half. The histograms of the first vertical half and the second vertical half and the histograms of the first horizontal half and the second horizontal half can each represent pixel value frequencies in one of the first vertical half, the second vertical half, the first horizontal half, and the second horizontal half of the image. Steps 710 and 712 can include the processor 120 executing the similarity and histogram scoring operation 312.

At step 714, it is determined whether the image is a LR stereo image type, a TB stereo image type, or a mono image type using the first similarity score, the second similarity score, the first histogram score, and the second histogram score. This can include the processor 120 executing the score comparison operation 318. For example, in some embodiments, identifying whether the image is the LR stereo image type, the TB stereo image type, or the mono image type can include creating a first combined score using the first similarity score and the first histogram score, creating a second combined score using the second similarity score and the second histogram score, and using the first combined score and the second combined score to identify whether the image is the LR stereo image type, the TB stereo image type, or the mono image type. In various embodiments, the first combined score represents a likelihood that the image is the LR stereo image type, and the second combined score represents a likelihood that the image is the TB stereo image type. Identifying whether the image is the LR stereo image type, the TB stereo image type, or the mono image type can also include estimating that the image is one of the LR stereo image type or the TB stereo image type based on a score threshold and identifying whether the image is the LR stereo image type or the TB stereo image type based on a comparison of the first combined score and the second combined score. In other embodiments, identifying whether the image is the LR stereo image type, the TB stereo image type, or the mono image type can include determining a first prediction, based on a score threshold and using the first similarity score and the first histogram score, of whether the image is the LR stereo image type; determining a second prediction, based on the score threshold and using the second similarity score and the second histogram score, of whether the image is the TB stereo image type; identifying, if the first prediction indicates the image is the LR stereo image type, the image as the LR stereo image type; identifying, if the second prediction indicates the image is the TB stereo image type, the image as the TB stereo image type; and identifying, if the first prediction and the second prediction indicate the image is neither the LR stereo image type nor the TB stereo image type, the image as the mono image type.

Although FIG. 7 illustrates one example of a method 700 for identifying the stereo mode for an image, various changes may be made to FIG. 7. For example, while shown as a series of steps, various steps in FIG. 7 could overlap, occur in parallel, occur in a different order, or occur any number of times (including zero times).

It should be noted that the functions shown in FIGS. 2 through 7 or described above can be implemented in an electronic device 101, 102, 104, server 106, or other device(s) in any suitable manner. For example, in some embodiments, at least some of the functions shown in FIGS. 2 through 7 or described above can be implemented or supported using one or more software applications or other software instructions that are executed by the processor 120 of the electronic device 101, 102, 104, server 106, or other device(s). In other embodiments, at least some of the functions shown in FIGS. 2 through 7 or described above can be implemented or supported using dedicated hardware components. In general, the functions shown in FIGS. 2 through 7 or described above can be performed using any suitable hardware or any suitable combination of hardware and software/firmware instructions. Also, the functions shown in FIGS. 2 through 7 or described above can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
obtaining, using at least one processing device of an electronic device, an image;
dividing, using the at least one processing device, the image vertically into a first vertical half and a second vertical half;
determining, using the at least one processing device, a first similarity score representing a similarity between the first vertical half and the second vertical half, wherein the first similarity score is based on pixel differences between the first vertical half and the second vertical half;
determining, using the at least one processing device, a first histogram score representing a resemblance between histograms of the first vertical half and the second vertical half;
dividing, using the at least one processing device, the image horizontally into a first horizontal half and a second horizontal half;
determining, using the at least one processing device, a second similarity score representing a similarity between the first horizontal half and the second horizontal half, wherein the second similarity score is based on pixel differences between the first horizontal half and the second horizontal half;
determining, using the at least one processing device, a second histogram score representing a resemblance between histograms of the first horizontal half and the second horizontal half; and
identifying, using the at least one processing device, whether the image is a left-right (LR) stereo image type, a top-bottom (TB) stereo image type, or a mono image type using the first similarity score, the second similarity score, the first histogram score, and the second histogram score.

2. The method of claim 1, wherein identifying whether the image is the LR stereo image type, the TB stereo image type, or the mono image type includes:
creating a first combined score using the first similarity score and the first histogram score;
creating a second combined score using the second similarity score and the second histogram score; and
using the first combined score and the second combined score to identify whether the image is the LR stereo image type, the TB stereo image type, or the mono image type.

3. The method of claim 2, wherein:
the first combined score represents a likelihood that the image is the LR stereo image type; and
the second combined score represents a likelihood that the image is the TB stereo image type.

4. The method of claim 3, wherein identifying whether the image is the LR stereo image type, the TB stereo image type, or the mono image type further includes:
estimating that the image is one of the LR stereo image type or the TB stereo image type based on a score threshold; and
identifying whether the image is the LR stereo image type or the TB stereo image type based on a comparison of the first combined score and the second combined score.

5. The method of claim 1, wherein identifying whether the image is the LR stereo image type, the TB stereo image type, or the mono image type includes:
determining a first prediction, based on a score threshold and using the first similarity score and the first histogram score, of whether the image is the LR stereo image type;
determining a second prediction, based on the score threshold and using the second similarity score and the second histogram score, of whether the image is the TB stereo image type;
identifying, if the first prediction indicates the image is the LR stereo image type, the image as the LR stereo image type;
identifying, if the second prediction indicates the image is the TB stereo image type, the image as the TB stereo image type; and
identifying, if the first prediction and the second prediction indicate the image is neither the LR stereo image type nor the TB stereo image type, the image as the mono image type.

6. The method of claim 1, further comprising:
normalizing the first vertical half and the second vertical half for exposure and/or brightness prior to determining the first similarity score; and
normalizing the first horizontal half and the second horizontal half for exposure and/or brightness prior to determining the second similarity score.

7. The method of claim 1, wherein the histograms of the first vertical half and the second vertical half and the histograms of the first horizontal half and the second horizontal half each represent pixel value frequencies in the one of the first vertical half, the second vertical half, the first horizontal half, and the second horizontal half of the image.

8. An electronic device comprising:
at least one processing device configured to:
obtain an image;
divide the image vertically into a first vertical half and a second vertical half;
determine a first similarity score representing a similarity between the first vertical half and the second vertical half, wherein the first similarity score is based on pixel differences between the first vertical half and the second vertical half;
determine a first histogram score representing a resemblance between histograms of the first vertical half and the second vertical half;
divide the image horizontally into a first horizontal half and a second horizontal half;
determine a second similarity score representing a similarity between the first horizontal half and the second horizontal half, wherein the second similarity score is based on pixel differences between the first horizontal half and the second horizontal half;
determine a second histogram score representing a resemblance between histograms of the first horizontal half and the second horizontal half; and
identify whether the image is a left-right (LR) stereo image type, a top-bottom (TB) stereo image type, or a mono image type using the first similarity score, the second similarity score, the first histogram score, and the second histogram score.

9. The electronic device of claim 8, wherein, to identify whether the image is the LR stereo image type, the TB stereo image type, or the mono image type, the at least one processing device is configured to:
create a first combined score using the first similarity score and the first histogram score;
create a second combined score using the second similarity score and the second histogram score; and
use the first combined score and the second combined score to identify whether the image is the LR stereo image type, the TB stereo image type, or the mono image type.

10. The electronic device of claim 9, wherein:
the first combined score represents a likelihood that the image is the LR stereo image type; and
the second combined score represents a likelihood that the image is the TB stereo image type.

11. The electronic device of claim 10, wherein, to identify whether the image is the LR stereo image type, the TB stereo image type, or the mono image type, the at least one processing device is further configured to:
estimate that the image is one of the LR stereo image type or the TB stereo image type based on a score threshold; and
identify whether the image is the LR stereo image type or the TB stereo image type based on a comparison of the first combined score and the second combined score.

12. The electronic device of claim 8, wherein, to identify whether the image is the LR stereo image type, the TB stereo image type, or the mono image type, the at least one processing device is configured to:
determine a first prediction, based on a score threshold and using the first similarity score and the first histogram score, of whether the image is the LR stereo image type;
determine a second prediction, based on the score threshold and using the second similarity score and the second histogram score, of whether the image is the TB stereo image type;
identify, if the first prediction indicates the image is the LR stereo image type, the image as the LR stereo image type;
identify, if the second prediction indicates the image is the TB stereo image type, the image as the TB stereo image type; and
identify, if the first prediction and the second prediction indicate the image is neither the LR stereo image type nor the TB stereo image type, the image as the mono image type.

13. The electronic device of claim 8, wherein the at least one processing device is further configured to:
normalize the first vertical half and the second vertical half for exposure and/or brightness prior to determining the first similarity score; and
normalize the first horizontal half and the second horizontal half for exposure and/or brightness prior to determining the second similarity score.

14. The electronic device of claim 8, wherein the histograms of the first vertical half and the second vertical half and the histograms of the first horizontal half and the second horizontal half each represent pixel value frequencies in the one of the first vertical half, the second vertical half, the first horizontal half, and the second horizontal half of the image.

15. A non-transitory machine readable medium comprising instructions that when executed cause at least one processor of an electronic device to:
obtain an image;
divide the image vertically into a first vertical half and a second vertical half;
determine a first similarity score representing a similarity between the first vertical half and the second vertical half, wherein the first similarity score is based on pixel differences between the first vertical half and the second vertical half;
determine a first histogram score representing a resemblance between histograms of the first vertical half and the second vertical half;
divide the image horizontally into a first horizontal half and a second horizontal half;
determine a second similarity score representing a similarity between the first horizontal half and the second horizontal half, wherein the second similarity score is based on pixel differences between the first horizontal half and the second horizontal half;
determine a second histogram score representing a resemblance between histograms of the first horizontal half and the second horizontal half; and
identify whether the image is a left-right (LR) stereo image type, a top-bottom (TB) stereo image type, or a mono image type using the first similarity score, the second similarity score, the first histogram score, and the second histogram score.

16. The non-transitory machine readable medium of claim 15, wherein the instructions that when executed cause the at least one processor to identify whether the image is the LR stereo image type, the TB stereo image type, or the mono image type comprise instructions that when executed cause the at least one processor to:
create a first combined score using the first similarity score and the first histogram score;
create a second combined score using the second similarity score and the second histogram score; and
use the first combined score and the second combined score to identify whether the image is the LR stereo image type, the TB stereo image type, or the mono image type.

17. The non-transitory machine readable medium of claim 16, wherein the instructions that when executed cause the at least one processor to identify whether the image is the LR stereo image type, the TB stereo image type, or the mono image type further comprise instructions that when executed cause the at least one processor to:
estimate that the image is one of the LR stereo image type or the TB stereo image type based on a score threshold; and
identify whether the image is the LR stereo image type or the TB stereo image type based on a comparison of the first combined score and the second combined score.

18. The non-transitory machine readable medium of claim 15, wherein the instructions that when executed cause the at least one processor to identify whether the image is the LR stereo image type, the TB stereo image type, or the mono image type comprise instructions that when executed cause the at least one processor to:
determine a first prediction, based on a score threshold and using the first similarity score and the first histogram score, of whether the image is the LR stereo image type;
determine a second prediction, based on the score threshold and using the second similarity score and the second histogram score, of whether the image is the TB stereo image type;
identify, if the first prediction indicates the image is the LR stereo image type, the image as the LR stereo image type;
identify, if the second prediction indicates the image is the TB stereo image type, the image as the TB stereo image type; and
identify, if the first prediction and the second prediction indicate the image is neither the LR stereo image type nor the TB stereo image type, the image as the mono image type.

19. The non-transitory machine readable medium of claim 15, further comprising instructions that when executed cause the at least one processor to:
normalize the first vertical half and the second vertical half for exposure and/or brightness prior to determining the first similarity score; and
normalize the first horizontal half and the second horizontal half for exposure and/or brightness prior to determining the second similarity score.

20. The non-transitory machine readable medium of claim 15, wherein the histograms of the first vertical half and the second vertical half and the histograms of the first horizontal half and the second horizontal half each represent pixel value frequencies in the one of the first vertical half, the second vertical half, the first horizontal half, and the second horizontal half of the image.
